(19) United States
(12) Patent Application Publication
(10) Pub. No.: US 2007/0023073 A1
(43) Pub. Date: Feb. 1, 2007

(54) Collapsible walker

(75) Inventor: Shih-Peng Su, Yunlin County (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/439,241

(22) Filed: May 24, 2006

(30) Foreign Application Priority Data
Jul. 27, 2005 (TW) 094212766

(51) Int. Cl. A61H 3/00

(52) U.S. Cl. 135/67; 135/86; 482/68

(57) ABSTRACT

A walker with a foldable mechanism comprising an actuator which has an operating lever and an actuating groove. The actuator is rotated when a user laterally moves the operating lever, whereby an actuating groove pushes a positioning rod upward so as to release a fixed frame from a locked position into a folded state, thereby improving the safety of the user while the walker is use.

This application claims priority of Application No. 094212766 filed in Taiwan, R.O.C. on Jul. 27, 2005 under 35 U.S.C. § 119, the entire contents of which are hereby incorporated by reference.

### FIELD OF THE INVENTION

The present invention relates to a walker and, in particular, to a walker having an actuator which can be rotated laterally to release a positioning rod and unlock a fixed frame, thereby releasing the frame into a folded state.

### DESCRIPTION OF THE RELATED ART

After World War II, many countries underwent a baby boom, i.e., a temporary period of increased birth rates. Now that several decades have passed, these baby boomers are aging, resulting in a higher percentage of elderly people in the general population, whereby the elderly are now a major consumer group. Accordingly, many products are designed to meet the demands of an elderly population, such as walking aids which can help support the elderly or infirm while walking.

A conventional walker is used to increase safety and steadiness for the elderly or infirm while walking. Unlike a cane, a walker is configured as an inverse-U shape so that the elderly or infirm can easily be positioned in the middle of the walker, thereby providing more stable support than a cane. However, the frame of a walker takes up more space than a cane, and may therefore not be convenient for carrying or storage, whether long term or temporary.

In order to overcome such shortcomings, a conventional walker has been improved with certain mechanisms which can fold each side of the frame for simplified storage or carrying. For example, Spies et al., U.S. Pat. No. 5,529,425 and Diamond, U.S. Pat. No. 6,886,575, use a lever that controls folding of each side of the frame, whereby a user can pull the lever to fold and draw close each side of the frame.

However, in the conventional art, the lever is adjacent to the handle grip, wherein the user may mistake the lever for a brake device and mistakenly cause the walker to fold. This can be dangerous a user operating the walker.

### SUMMARY OF THE INVENTION

A primary objective of the present invention is to overcome the shortcomings of the collapsible walkers found in the prior art, whereby a user is in danger of accidentally folding the walker. The present invention provides an actuator which has an operating lever and an actuating groove. The actuator can be rotated laterally to move the operating lever, and the actuating groove can then push a positioning rod upward to release the walker frame from a locked position into a collapsed or folded state.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a front, left perspective view of a collapsible walker of the present invention;

FIG. 2 is a top plan view of the collapsible walker of the present invention;

FIG. 3 is an exploded view of the collapsible walker of the present invention;

FIG. 4 is an partially exploded view showing the foldable mechanism of the collapsible walker of the present invention;

FIG.5 is a schematic view of the collapsible walker in a folded state.

FIG. 6 is a schematic and partially cross-sectional view showing the operation of the collapsible walker of the present invention.

### DETAILED DESCRIPTION OF THE PREFERRED EMBODIMENTS

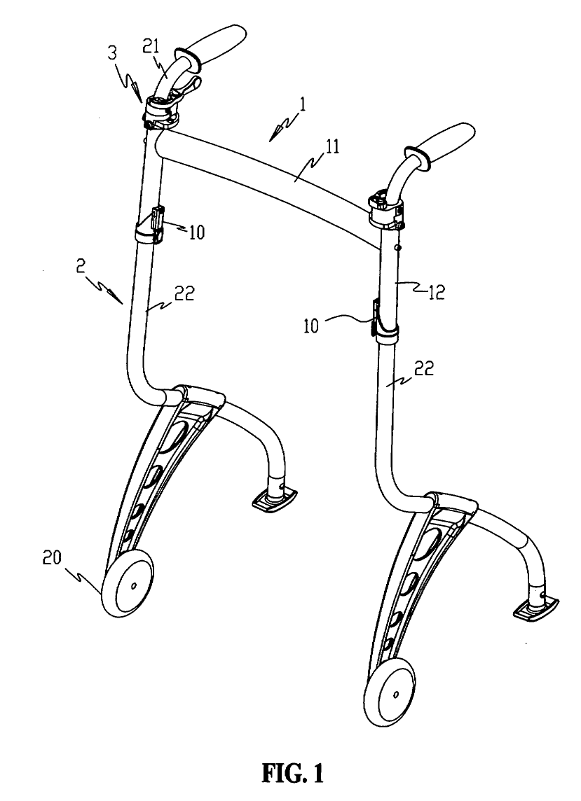

Referring to FIGS. 1, 2 and 3, the collapsible walker of present invention provides a mechanism that can be folded into a compact state to facilitate storage and carrying of the walker while not in use. Moreover, the structure provides simple and safe operation, whereby a user can avoid the danger inherent in unexpectedly folding the walker. This invention includes a fixed frame 1, a supporting frame 2, a foldable mechanism 3, a fixed base 4, a connecting base 5, an actuator 6, and a positioning rod 7.

The fixed frame 1 is configured in an H-like shape and includes a cross brace 11 and a pair of vertical tubes 12, wherein each of the lower ends of the vertical tubes 12 are provided with a height adjusting device 10.

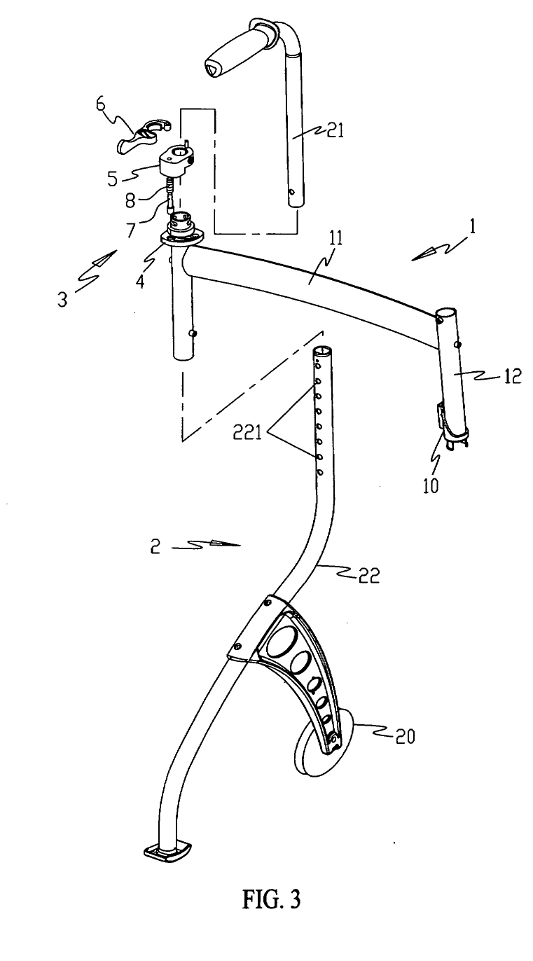

The supporting frame 2 is rotatably telescoped through the vertical tubes 12, which are disposed at opposite sides of the fixed frame 1. The support frame 2 comprises a pair of handle bars 21 and a pair of legs 22. As shown in FIG. 3, the leg 22 is configured in a T-like shape, and several adjusting holes 221 are vertically aligned on the leg 22, so that the user can adjust the height of the collapsible walker using the height adjusting device 10. In an embodiment of this invention, the supporting frame 2 is provided with an auxiliary wheel at its lower end. In addition, the handle bar 21 is telescoped to the leg 22.

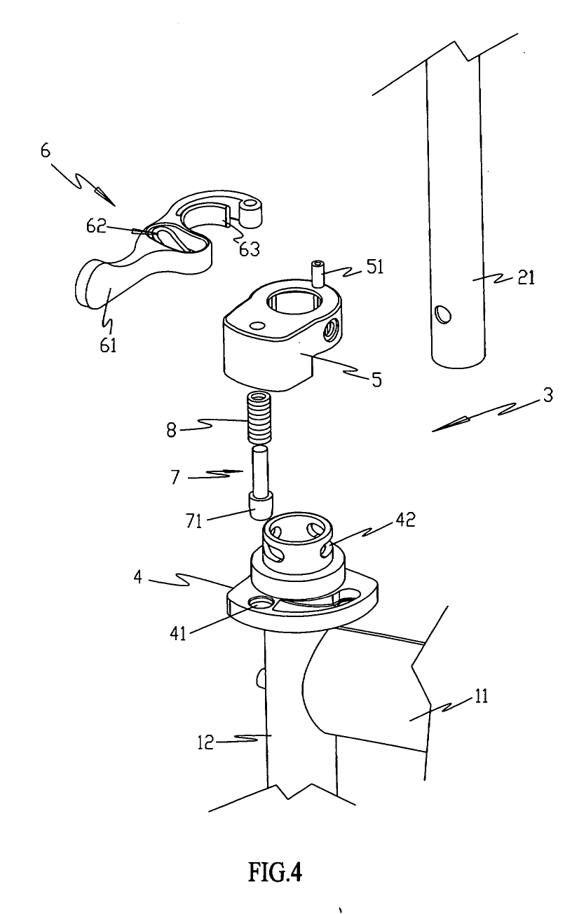

Referring additionally to FIGS. 3 and 4, a foldable mechanism 3 is disposed between the fixed frame 1 and the supporting frame 2, and comprises a fixed base 4, a connecting base 5, a actuator 6, a positioning rod 7 and an elastic member 8. The fixed base 4 is fixed to upper end of the vertical tube 12 of the fixed frame 1, wherein the fixed base 4 includes a positioning aperture 41 for fixing the frame in its expanded state, and a guiding slot 42 arranged at the upper end for guiding the rotation of the connecting base 5.

The connecting base 5 is telescoped to the handle bar 21 of the supporting frame 2, and can be rotated upon the fixed base 4. The connecting base also includes a pivot portion 51.

The actuator 6, as shown in FIG. 4, is rotatably pivoted to the pivot portion 51 of the connecting base 5, and comprises an operating lever 61, an actuating groove 62 and a elastic portion 63, which are formed as one piece with the actuator 6.

The positioning rod 7 is movably connected between the connecting base 5 and the actuating groove 62 of the actuator 6, and an end portion 71 of the positioning rod 7 is provided for locking the positioning aperture 41 of the fixed base 4.

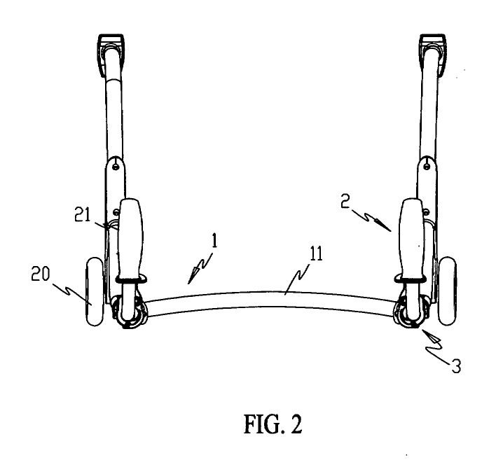

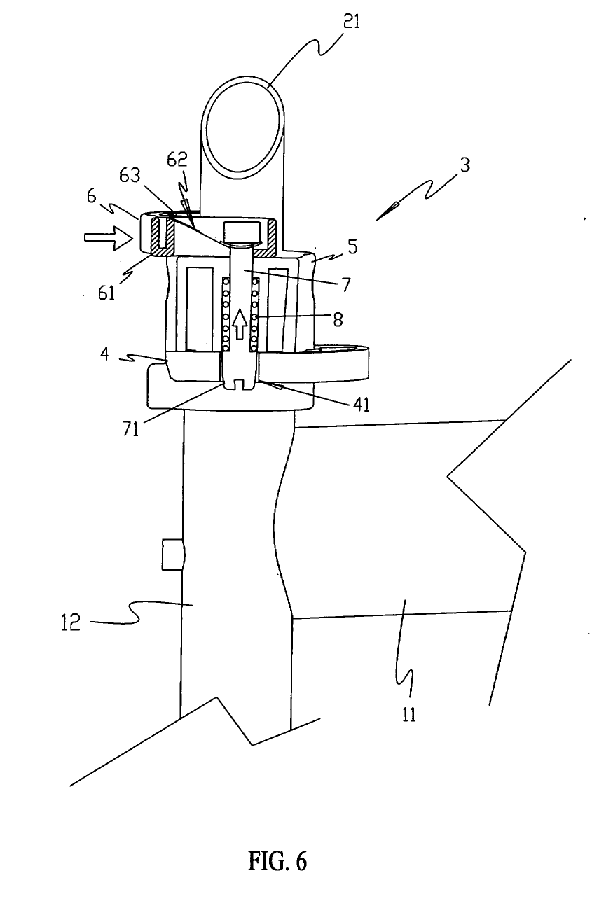

Referring to FIG. 6, which demonstrates the operation of various components of the foldable mechanism 3, the positioning rod 7 can be locked within the positioning aperture 41 by the force of the elastic member 8, so as to fix the fixed frame 1 and the supporting frame 2 in an expanded, inverted U-like state, as is shown in FIG. 2. This feature helps to support, protect and assist the user in walking.

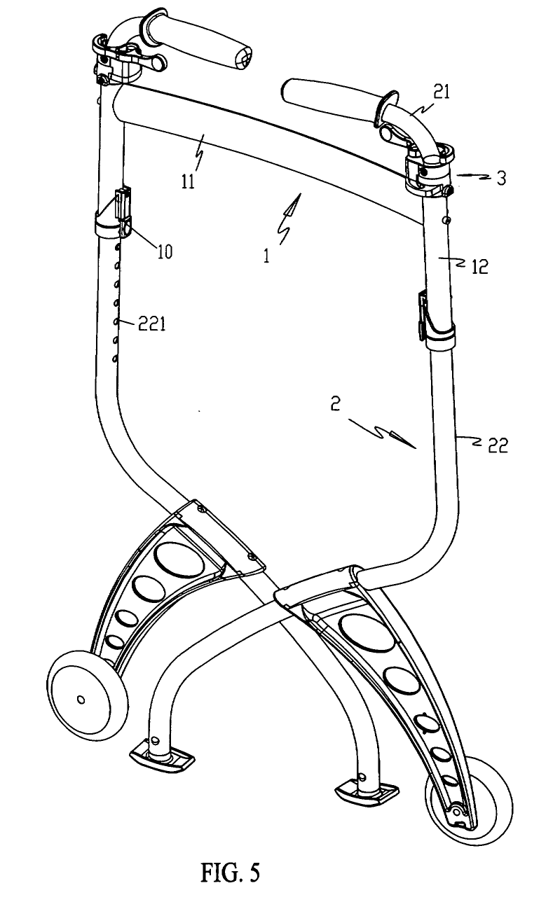

Upon folding of the frame, the user can rotate the actuator 6 by moving the operating lever 61 laterally. Since the actuating groove 62 of the actuator has a slope, the positioning rod 7 can be pushed upward, allowing the end portion 71 of the positioning rod to disengage from the positioning aperture 41. Therefore, the supporting frame 2 can be rotated and folded as a parallel configuration with the fixed frame 1, as is shown in FIG. 5.

When it is necessary for the user to expand the supporting frame 2, the elastic portion 63 of the actuator 6 provides force to move the positioning rod 7 into the lowest point of the actuating groove 62, thereby enabling the end portion 71 of the positioning rod 7 to automatically enter and lock within the positioning aperture 41. This fixes the supporting frame 2 into an expanded state.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A collapsible walker having a foldable mechanism, comprising:
a fixed frame and a supporting frame, wherein the supporting frame is rotatably mounted on opposite sides of the fixed frame and the foldable mechanism is disposed between the fixed frame and the supporting frame, the foldable mechanism having:
a fixed base with a positioning aperture, the fixed base being fixedly connected to the fixed frame;
a connecting base rotatably connected to the supporting frame, the connecting base being provided with a pivot portion;
an actuator connected to the pivot portion of the connecting base being provided with an operating lever and a actuating groove; and
a positioning rod movably mounted between the connecting base and the actuator, wherein an elastic member locks an end portion of the positioning rod with the positioning aperture, so as to maintain the fixed frame and the supporting frame in an inverted U-like shape after being expanded, and wherein, upon folding, the positioning rod is moved into the actuating groove so as to disengage the end portion from the positioning aperture and rotate and fold the supporting frame into a configuration substantially parallel to the fixed frame.

2. The collapsible walker of claim 1, wherein the fixed frame includes a cross brace and a pair of vertical tubes connected to each other in an H-like shape.

3. The collapsible walker of claim 2, wherein an upper end of the vertical tube is fixed to the fixed base, and wherein a height adjusting device is disposed at a lower end of the vertical tube.

4. The collapsible walker of claim 1, wherein the supporting frame has a handle bar and a leg, the handle bar being telescoped to the leg, and the leg having a plurality of adjusting holes, wherein the adjusting holes associate with an adjusting device to adjust the relative height of the leg and the handle bar.

5. The collapsible walker of claim 1, wherein the foldable mechanism can be rotated along with the supporting frame, independently of the fixed base.

6. The collapsible walker of claim 1, wherein the actuator further comprises an elastic portion which enables the positioning rod to automatically enter and lock with the positioning aperture after the supporting frame is expanded.

7. The collapsible walker of claim 6, wherein the elastic portion is formed as one piece with the actuator.
